(19) United States
(12) Patent Application Publication
(10) Pub. No.: US 2011/0049829 A1
(43) Pub. Date: Mar. 3, 2011

(54) Suspension Strut and Thrust Bearing Device

(76) Inventors: Jean-Sylvain Migliore, Gif sur Yvette (FR); Samuel Viault, Tours (FR); Florence Crenn, Amboise (FR)

(21) Appl. No.: 12/678,846

(22) PCT Filed: Sep. 5, 2008
(86) PCT No.: PCT/EP08/61796

§ 371 Date: Oct. 26, 2010

(30) Foreign Application Priority Data
Sep. 19, 2007 (FR) 0757683

(51) Int. Cl. B60G 15/00; F16C 19/30

(52) U.S. Cl. 280/124.146; 384/618

(57) ABSTRACT

Suspension thrust bearing device (5), particularly for a motor vehicle, comprising a rolling bearing forming an axial thrust bearing and an annular end plate (18) provided with means of axial retention of the rolling bearing, the rolling bearing comprising an upper ring (15), a lower ring (16) and a plurality of rolling elements (17) positioned between the upper ring and the lower ring. The device comprises both a dynamic seal (19b) between the end plate (18) and the lower ring (16), and a static seal (19a) between the end plate (18) and the upper ring (15).

The present invention relates to the field of suspension thrust bearing devices used, particularly on motor vehicles, in suspension struts for the steered wheels.

As is known, from document US 2007/0009190, a suspension thrust bearing may comprise a rolling bearing equipped with two rings and with a row of rolling elements covered by a flange extending around the upper ring and around part of the lower ring. The end plate ends at the bottom in an inwardly directed rim.

This type of thrust bearing presents the problem of possible contamination by the ingress of water or of other contaminants. A suspension thrust bearing is actually positioned at a location that is particularly exposed to being splashed with water and other contaminants. When this type of thrust bearing is subjected to fierce sprays of water, for example when the vehicle is driving along a flooded road or alternatively when the vehicle is being cleaned with a high pressure jet of water, water may enter the rolling bearing to the detriment of the life of the said bearing. The ingress of water may be via the lower part of the thrust bearing, between the cover and the lower ring, or may equally well be via the upper part, infiltrating between the cover and the upper ring.

Document FR 2 665 494 discloses an axial rolling bearing, the cage of which is fitted with sealing lips. However, the material of a cage has to be rigid, while the material of a sealing lip needs to be flexible.

Document U.S. Pat. No. 5,344,241 discloses a tapered thrust bearing fitted with a seal. However, the shape of the component encourages water retention and is therefore unable effectively to guard against infiltration of water.

Document FR 2 866 085 relates to a flywheel axial thrust bearing provided with a rubbing lip. This device is ill-suited to use along a substantially vertical axis and therefore presents risks of water ingress.

It is a particular object of the invention to overcome the abovementioned disadvantages. A particular object of the invention is to reduce the probability of the ingress of water or other contaminants into a suspension thrust bearing. It is an object of the invention to avoid the ingress of water from the top and from the bottom of the thrust bearing.

The suspension thrust bearing device comprises a rolling bearing and an annular end plate provided with means of axial retention of the elements of the thrust bearing. The rolling bearing comprises an upper ring, a lower ring and a plurality of rolling elements positioned between the rings. The device comprises both a dynamic seal between the end plate and the lower ring, and a static seal between the end plate and the upper ring. This therefore spares the interior of the rolling bearing from the ingress of undesirables.

In one embodiment, the end plate bears the dynamic seal and the static seal. The mounting of the thrust bearing is facilitated thereby.

In one embodiment, the dynamic seal comprises at least one lip bearing against the lower ring of the thrust bearing.

In one embodiment, the static seal comprises a layer of flexible material at least partially coating an interior surface of the end plate, the said layer being in contact with the upper ring. In other words, the static seal comprises a packing positioned between the end plate and the upper ring. The packing may comprise a radial portion and a substantially toroidal portion.

In one embodiment, the dynamic seal and the static seal are overmoulded onto the end plate. Overmoulding can be done simultaneously to make manufacturing easier.

In one embodiment, the dynamic seal and the static seal are made of the same material. The said material may comprise an elastomer, for example of the synthetic rubber type.

In one embodiment, the dynamic seal and the static seal are connected to one another by flexible material. The end plate and the upper ring may be positioned a short distance apart, delimiting a space in which the static seal is positioned, this static seal also attenuating the transmission of noise and vibration.

In one embodiment, the dynamic seal is set back axially from the free end of an axial portion of the end plate.

In one embodiment, the end plate comprises an axial portion provided with an end bent back obliquely towards the lower ring. Means of axial retention are thus formed. The risk that components will become lost while the thrust bearing is being handled prior to its being mounted in a strut is thus lessened.

The invention also relates to a strut comprising a suspension thrust bearing device and a shock absorber. The suspension thrust bearing device may be mounted around a rod of the shock absorber. A spring may be positioned around the shock absorber and connected to the thrust bearing by a spring cup.

By virtue of the invention, the risk of water or contaminant ingress into the suspension thrust bearing rolling bearing part of the suspension thrust bearing is particularly low.

The present invention will be better understood from reading the detailed description of one embodiment taken by way of entirely nonlimiting example and illustrated by the attached drawings, in which:

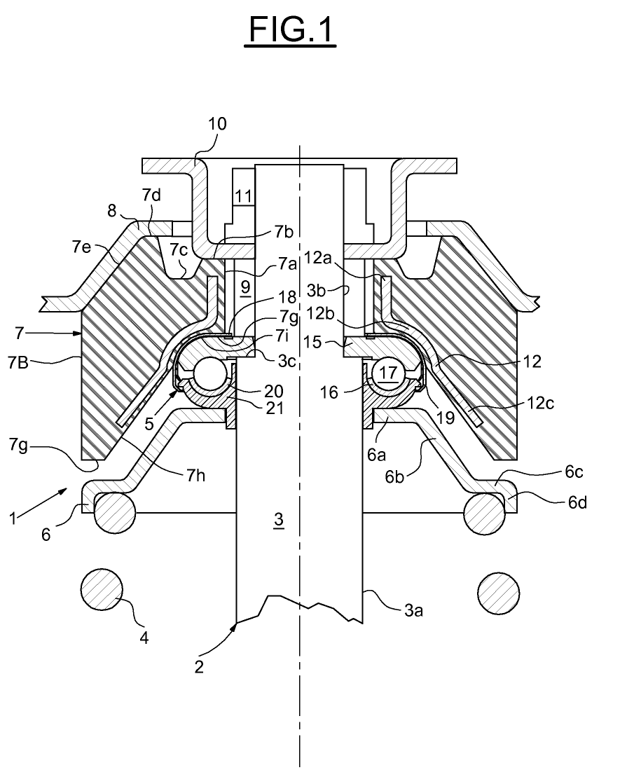

FIG. 1 is a view in axial section of a strut;

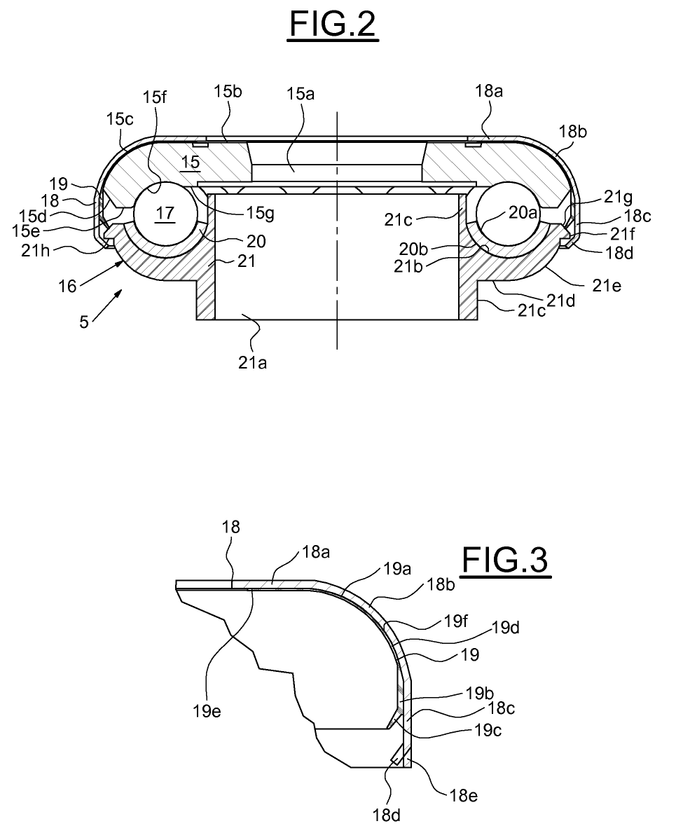

FIG. 2 is a view in axial section of a suspension thrust bearing device; and

FIG. 3 is a detailed view of FIG. 2.

As may be seen in FIG. 1, the strut 1 comprises a shock absorber 2 provided with a rod 3, a spring 4, a thrust bearing 5 mounted around the rod 3, a cap 6 forming the interface between the spring 4 and the thrust bearing 5 and an elastic block 7 mounted between the thrust bearing 5 and the body 8 of a vehicle in which the strut 1 is mounted. The shock absorber 2 is visible only in part, the shock absorber cylinder not having been depicted through lack of space. The rod 3 of the shock absorber has a large-diameter axial exterior surface 3a, a small-diameter axial exterior surface 3b, the axial surfaces 3a and 3b being separated by a shoulder 3c.

The strut 1 also comprises an axial spacer piece 9 positioned around the small-diameter axial surface 3b, a clamping cup 10 and a nut 11 collaborating with a threaded portion of the small-diameter axial surface 3b near the free end of the rod 3. The nut 11 provides the axial connection between the elastic block 7, the spacer piece 9 and the thrust bearing 5, the spacer piece 9 being positioned in the space radially bounded by the small-diameter axial surface 3b of the shock absorber rod 3 and a bore 7a in the elastic block 7.

The cap 6 is in the form of a sheet metal annular component comprising a small-diameter radial portion 6a in contact with the thrust bearing 5, a frustoconical portion 6b extending outwards and downwards, that is to say away from the free end of the shock absorber rod 3, a large-diameter radial portion 6c, against which the end turn of the spring 4 rests, and a rim 6d of axial overall shape serving to centre the end turn of the spring 4.

The elastic block 7 may be made of a flexible material such as an elastomer, into which, as an option, one or more strengthening rigid inserts 12, for example metal inserts, may be inserted. In the embodiment of FIG. 1, the insert 12 is in the form of an annular component, comprising a small-diameter axial portion 12a, a substantially toroidal portion 12b and a frustoconical portion 12c extending outwards and towards the spring 4. The insert 12 may be embedded in the elastic material while at the same time lying a short distance away from the thrust bearing 5.

The elastic block 7 has an annular radial surface 7b adjacent to the bore 7a and in contact with a radial surface of the clamping cup 10, an annular groove 7c open at the top, towards the body 8, a short upper annular radial surface 7d in contact with a radial surface of the body 8, a frustoconical surface 7e extending outwards and downwards, towards the spring 4 from the exterior edge of the radial surface 7d and in contact with the body 8, a substantially axial surface 7f extending from the body 8 towards the spring 4, a lower radial portion 7g positioned a short distance away from the large-diameter radial portion 6c of the bearing cap 6 and directed inwards from the exterior axial surface 7f, a frustoconical surface 7h substantially parallel to the frustoconical portion 6b of the bearing cap 6 and extending inwards and upwards from the interior edge of the lower radial surface 7g, and a substantially toroidal surface 7i where the lower frustoconical surface 7h and the axial bore 7a meet. If appropriate, a small-sized radial surface 7g may be provided between the substantially toroidal surface 7i and the bore 7a.

The thrust bearing 5 comprises an upper ring 15, a lower ring 16, a row of rolling elements 17, in this instance balls, a retaining end plate 18 and a sealing packing 19. The upper ring 15 is in the form of an annular component in which there is formed a central bore 15a that creates a passage for the upper portion of the shock absorber rod 3, particularly for the small-diameter axial surface 3b.

The upper ring 15 also comprises a radial upper surface 15b extending outwards from the bore 15a, a toroidal surface 15c extending outwards and downwards from the radial upper surface 15b, a small-sized frustoconical surface 15d extending inwards and downwards from the toroidal surface 15c, a lower radial surface 15e extending inwards from the frustoconical surface 15d, a toroidal surface 15f which in meridian axial section is of concave shape and which forms a raceway for the rolling elements 17, and a radial surface 15g extending between the toroidal surface 15f and the bore 15a.

The upper ring 15 may be of one piece. The upper ring 15 is axially clamped between the spacer piece 9 and the shoulder 3c.

The lower ring 16 is made in two parts and comprises a cup 21, for example made of a synthetic material, and an attached track 20, for example made of sheet metal. The attached track 20 is of annular overall shape. The attached track 20 may be produced by cutting and pressing a sheet metal blank, and this is a particularly economical way of producing it. The attached track 20 offers a concave surface 20a forming a raceway for the rolling elements 17 and a lower surface 20b which in meridian axial section is of convex shape.

The cup 21 is able to offer shapes that are more complex than the attached track 20 and has a bore 21a in contact with the large-diameter axial surface 3a of the shock absorber rod 3, an upper toroidal surface 21b in contact with the lower surface 20b of the attached raceway track 20, and an annular projection 21c of axial overall shape between the bore 21a and the toroidal surface 21b. The projection 21c extends axially upwards towards the upper ring 15.

The cup 21 also comprises an exterior axial surface 21c positioned axially on the same side as the spring 4 and capable of being in contact with the bore of the bearing cap 6, a radial bearing surface 21d for the small-diameter radial portion 6a of the bearing cap 6 substantially aligned with the rolling elements 17 so that the cup 21 essentially transmits axial load, an exterior rounded surface 21e meeting outwards and upwards with a hook 21f equipped with a lower radial surface 21h that extends outwards. The cup 21 also comprises a frustoconical surface 21g extending upwards and inwards from the hook 21f.

The end plate 18 may be in the form of a thin sheet metal component. The end plate 18 is of annular overall shape. The end plate 18 comprises a small-diameter radial portion 18a positioned in at least partial contact with the elastic block 7, particularly with the radial surface 7g, a substantially toroidal portion 18b extending outwards and downwards from the radial portion 18a also in contact with the elastic block 7, particularly with the toroidal surface 7i, a substantially axial portion 18c extending downwards from the toroidal portion 18b and surrounding the hook 19f of the cup 19 of the lower ring 16, and a frustoconical rim 18d extending downwards and inwards for the purpose of interfering diametrically with the hook 19f if there is any accidental axial movement of the lower ring 16 with respect to the upper ring 15, particularly during handling and transport prior to the fitting of the strut.

The suspension thrust bearing 5 thus forms a ready-to-fit subassembly with a low likelihood of components being lost. The rim 18d may start out substantially axial, see reference 18e in FIG. 3, then be bent into its definitive frustoconical shape once the thrust bearing 5 has been assembled.

The packing 19 is positioned partly between the upper ring 15 and the end plate 18. The sealing packing 19 may comprise a flexible material, for example an elastomer such as a synthetic rubber. The sealing packing 19 comprises a part 19a that forms a static seal, clamped between the upper ring 15 and the end plate 18 and conforming shape-wise to the toroidal surface 15c and the toroidal portion 18b, and a part 19b forming a dynamic seal, of a greater thickness than the static seal part 19a, and that has a lip 19c that rubs against the frustoconical surface 21g of the cup 21 of the lower ring 16, thus providing a high level sealing for the rolling bearing.

In this description, the expression “static seal” means sealing between two elements that is afforded by a contact that involves no relative motion and the expression “dynamic seal” means sealing afforded by a contact or a collaboration that does involve relative motion.

Water or other undesirables cannot infiltrate between the upper ring 15 and the end plate 18 because of the presence of the static seal part 19a which in particular comprises a small-diameter radial portion 19e and a large-diameter toroidal portion 19f. Likewise, water or undesirables are prevented from infiltrating downwards, particularly through the narrow passage formed between the frustoconical rim 18d and the surface 21h of the hook 21f and especially via the dynamic seal part 19b, the lip 19c of which rubs against the frustoconical surface 21g of the cup 21 of the lower ring 16. This then prevents the ingress of water, particularly when driving along very wet or flooded road or alternatively when cleaning with a water jet, particularly a high pressure one.

The upper ring 15 is clamped between the shoulder 3c of the shock absorber rod 3 and the spacer piece 9 against which the cup 10 and the nut 11 bear. The end plate 18 has an inside diameter greater than the outside diameter of the spacer piece 9. The end plate 18 provides axial retention of the lower ring 16 before the strut is fitted and acts as a support framework for the dynamic part 19b of the sealing packing 19. Advantageously, the sealing packing 19 is overmoulded into the end plate 18. In the embodiment depicted, the sealing packing 19 is of one piece. The sealing packing 19 comprises a portion 19d where the static seal part 19a and the dynamic seal part 19b meet. In an alternative that has not been depicted, the sealing packing is made as a static seal part and a dynamic seal part, which parts are separate from one another.

For reasons of ease and cost of manufacture, it is preferable for the static and dynamic seal parts to be made of the same material.

In other words, the suspension thrust bearing device comprises an upper ring and a lower ring between which rolling elements, such as balls or rollers, are positioned. The rings may have in-built or attached raceways. One ring may comprise a cup made of plastic and an attached raceway made of steel. The suspension thrust bearing may bear against the body of the vehicle directly or via a cup and/or an elastic block that filters out vibration in particular. The spring positioned around the shock absorber bears via its lower end against a lower cup secured to the shock absorber cylinder and bears directly or indirectly via its upper end against the lower cap. The upper end of the rod of the shock absorber piston is secured to the elastic support block so as to filter out vibration travelling up towards the body of the vehicle. The bump stop thrust bearing is thus able to transmit axial load between the spring and the body of the vehicle while at the same time allowing a relative angular movement between the spring and the body of the vehicle as the steered wheels of the vehicle are turned and/or as the spring compresses.

The sealing lip 19c of the dynamic seal part 19b of the sealing packing 19 may be vulcanized onto the interior surface of the cylindrical axial portion of the end plate approximately mid-way up the said portion. Of course, the dynamic seal part 19b may, by way of an alternative, comprise a plurality of rubbing lip seals.

By virtue of the invention, the risk of water finding its way into the rolling bearing and therefore of causing the rapid deterioration of the suspension thrust bearing is greatly reduced.

1. A suspension thrust bearing device for a motor vehicle, the device comprising:
a rolling bearing forming an axial thrust bearing and including an upper ring, a lower ring and a plurality of rolling elements positioned between the upper ring and the lower ring,
an annular end plate configured to axially retain the rolling bearing,
a dynamic seal disposed between the end plate and the lower ring, and
a static seal disposed between the end plate and the upper ring.

2. The device according to claim 1, wherein the end plate bears the dynamic seal and the static seal.

3. The device according to claim 1, wherein the dynamic seal includes at least one lip bearing against the lower ring of the thrust bearing.

4. The device according to claim 1, wherein the static seal includes a layer of flexible material at least partially coating an interior surface of the end plate, the layer being in contact with the upper ring.

5. The device according to claim 1, wherein the dynamic and static seals are overmoulded onto the end plate.

6. The device according to claim 1, wherein the dynamic and static seals are made of the same material.

7. The device according to claim 1, wherein the dynamic and static seals are connected by a flexible material.

8. The device according to claim 1, wherein the dynamic seal spaced axially from the free end of an axial portion of the end plate.

9. The device according to claim 1, wherein the end plate includes a lower axial portion with an oblique free end extending towards the lower ring and configured to axially retain the lower ring with respect to the end plate.

10. A strut comprising;
a shock absorber, and
a suspension thrust bearing device comprising:
a rolling bearing forming an axial thrust bearing and including an upper ring, a lower ring and a plurality of rolling elements positioned between the upper ring and the lower ring,
an annular end plate configured to axially retain the rolling bearing,
a dynamic seal disposed between the end plate and the lower ring, and
a static seal disposed between the end plate and the upper ring.
